(19) United States
(12) Patent Application Publication
(10) Pub. No.: US 2025/0212010 A1
(43) Pub. Date: Jun. 26, 2025

(54) SYSTEM AND METHOD FOR OPTIMAL LOCATION IDENTIFICATION OF MESH NODES

(71) Applicant: DISH Network Technologies India Private Limited, Bangalore (IN)

(72) Inventors: Mansoor Ahmed, Karnataka (IN); Suresh Napa, Miyapur (IN); Vinay Kumar Reddy Kommireddy, Andhra Pradesh (IN)

(21) Appl. No.: 18/391,372

(22) Filed: Dec. 20, 2023

(51) Int. Cl. H04W 16/18; H04B 17/309; H04W 24/08; H04W 84/12

(52) U.S. Cl. CPC H04W 16/18; H04B 17/309; H04W 24/08; H04W 84/12

(57) ABSTRACT

A system and method for optimal location identification of mesh nodes in a Wi-Fi network is disclosed. The method includes obtaining information regarding a number and location of one or more user hotspots, obtaining information regarding an initial position of a mesh node with respect to the one or more user hotspots, performing benchmark throughput tests with one or more Wi-Fi enabled devices in the one or more user hotspots and the mesh node being moved between consecutive throughput tests, recommending moving the mesh node a distance and direction to improve benchmark throughput test results, displaying a mapping of throughput test data at the one or more user hotspots with respect to various testing positions of the mesh node, and determining an optimal position of the mesh node for throughput signal strength in the one or more user hotspots.

### BACKGROUND

### Technical Field

The present disclosure relates generally to a mesh node Wi-Fi network, and more particularly, but not exclusively, to a system and method for the determination of optimal location of mesh nodes in the network.

### Description of the Related Art

Just a decade or so ago, many high-end houses owned by technology savvy owners included high speed internet ports all over the house. Fast forward to today, a high speed internet is provided in houses owned by technology savvy owners almost entirely by Wi-Fi. In fact, not only are user computers (both laptop and desktop computers) being provided with high speed internet by Wi-Fi, users are relying on Wi-Fi for high speed internet to support mobile devices and even television signals (instead of cable or other wired signal transmission). Additionally, many smart devices in the user's home are also connecting to high speed internet via Wi-Fi, such as refrigerators, thermostats, home security systems, water heaters, AC systems, sprinkler systems, and the like.

With the increased reliance on Wi-Fi reception in the houses of technology savvy owners, a high number of owners are exhibiting extremely high requirement for their home Wi-Fi reception. As a result, many technology savvy owners are unsatisfied with the reception received using Wi-Fi networks due to these high standards and reception-inhibiting factors that were not sufficiently anticipated. These inhibiting factors include: (1) a weaker signal due to attenuation (loss) through a building's walls or other structures, (2) uncontrolled bouncing of signals within the room where the Wi-Fi enabled devices are located, (3) the number of Wi-Fi enabled devices to be covered by the Wi-Fi network, (4) the increasingly large sizes and shapes of the desired Wi-Fi coverage areas, and (5) interference with other electronic devices in a residence in which the Wi-Fi antenna is located.

The use of multiple routers and mesh Wi-Fi networks are some of the solutions that have been attempted to address these issues. Unfortunately, these attempted solutions have not satisfactorily addressed issues described above. There is a continuing need for a system that provides increased Wi-Fi mesh network reception coverage with users' houses. The present disclosure addresses this and other needs.

### BRIEF SUMMARY

The present disclosure is directed towards a mesh node signal optimization system for determining the optimal location of a mesh node in a Wi-Fi network to optimize signal throughput strength to Wi-Fi enabled devices in one or more user hotspots. The mesh node signal optimization system includes one or more processors and a memory device that stores a set of computer instructions. When the computer instructions are executed by the one or more processors, it causes the signal optimization system to: obtain information regarding a number and location of one or more user hotspots; obtain information regarding an initial position of a router with respect to the one or more user hotspots; obtain information regarding an initial position of a mesh node with respect to the one or more user hotspots; perform benchmark throughput tests with one or more Wi-Fi enabled devices in the one or more user hotspots, wherein the benchmark throughput tests of the one or more Wi-Fi enabled devices are performed at a plurality of known distances from the mesh node by moving the mesh node between consecutive throughput tests; recommend moving the mesh node a distance and direction to improve benchmark throughput test results with the one or more Wi-Fi enabled devices in the one or more user hotspots; reperform the benchmark throughput tests of the one or more Wi-Fi enabled devices in the one or more user hotspots with the mesh node moved the recommended distance and direction; display a mapping of throughput test data at the one or more user hotspots with respect to various testing positions of the mesh node; and notify of an optimal position of the mesh node for throughput signal strength in the one or more user hotspots.

In some embodiments of the mesh node signal optimization system, the memory further includes computer-executable instructions that further cause the processor to identify a size and shape of each user hotspot in the one or more user hotspots. In another aspect of some embodiments of the mesh node signal optimization system, the memory further includes computer-executable instructions that further cause the processor to perform one or more of: obtain Bluetooth readings to assist with mesh node placement, obtain Global Positioning System (GPS) readings to assist with mesh node placement, and obtain local positioning system readings to assist with mesh node placement.

In still another aspect of some embodiments, the mesh node signal optimization system recommends router movement for signal strength optimization with respect to the one or more user hotspots. In yet another aspect of some embodiments, the mesh node signal optimization system recommends signal strength optimization for a highest minimum throughput across all of the one or more user hotspots. Further, in another aspect of some embodiments, the mesh node signal optimization system receives information regarding priority levels of the one or more user hotspots, and recommends signal strength optimization for peak throughput at the user hotspot with a highest priority level.

In one or more embodiments of the mesh node signal optimization system, the mapping of throughput test data with respect to various locations of the mesh node is a signal throughput strength heat map. In still another aspect of some embodiments, the mesh node signal optimization system recommends that an additional mesh node be added to maintain a highest minimum throughput across all of the one or more user hotspots, and recommends an optimal location of the additional mesh node to be added. In still another aspect of some embodiments of the mesh node signal optimization system, the memory further includes computer-executable instructions that further cause the processor to: recommend further moving the mesh node a distance and direction to improve benchmark throughput test results with the one or more Wi-Fi enabled devices in the one or more user hotspots; and additionally, reperform the benchmark throughput tests of the one or more Wi-Fi enabled devices in the one or more user hotspots with the mesh node further moved the recommended distance and direction.

Additionally, embodiments described herein are directed towards a mesh node signal optimization method of optimizing location of a mesh node in a Wi-Fi network. The mesh node signal method includes: receiving information regarding a number and location of one or more user hotspots; receiving information regarding an initial position of a router with respect to the one or more user hotspots; receiving information regarding an initial position of a mesh node with respect to the one or more user hotspots; performing benchmark throughput tests with one or more Wi-Fi enabled devices in the one or more user hotspots, wherein the benchmark throughput tests of the one or more Wi-Fi enabled devices are performed at a plurality of known distances from the mesh node by moving the mesh node between consecutive throughput tests; recommending moving the mesh node a distance and direction to improve benchmark throughput test results with the one or more Wi-Fi enabled devices in the one or more user hotspots; reperforming benchmark throughput tests of the one or more Wi-Fi enabled devices in the one or more user hotspots with the mesh node moved the recommended distance and direction; displaying a mapping of throughput test data at all of the one or more user hotspots with respect to various testing positions of the mesh node; and notifying of an optimal position of the mesh node for throughput signal strength in the one or more user hotspots.

In some embodiments, the mesh node signal optimization method further includes obtaining a size and shape of each user hotspot in the one or more user hotspots. In another aspect of some embodiments, the mesh node signal optimization method further includes one or more of: obtaining Bluetooth readings to assist with mesh node placement; obtaining Global Positioning System (GPS) readings to assist with mesh node placement, and obtaining local positioning system readings to assist with mesh node placement. In still another aspect of some embodiments, the mesh node signal optimization method further includes recommending router movement for signal strength optimization with respect to the one or more user hotspots. In yet another aspect of some embodiments, the mesh node signal optimization method further includes recommending signal strength optimization for a highest minimum throughput across all of the one or more user hotspots.

Furthermore, in another aspect of some embodiments, the mesh node signal optimization method further includes receiving information regarding priority levels of the one or more user hotspots, and recommending signal strength optimization for peak throughput at the user hotspot with a highest priority level. In another aspect of some embodiments, the mapping of throughput test data with respect to various locations of the mesh node is a signal throughput strength heat map. In still another aspect of some embodiments, the mesh node signal optimization method further includes recommending that an additional mesh node be added to maintain a highest minimum throughput across all of the one or more user hotspots, and recommending an optimal location of the additional mesh node to be added. In yet another aspect of some embodiments, the mesh node signal optimization method further includes: recommending further moving the mesh node a distance and direction to improve benchmark throughput test results with the one or more Wi-Fi enabled devices in the one or more user hotspots; and additionally, reperforming benchmark throughput tests of the one or more Wi-Fi enabled devices in the one or more user hotspots with the mesh node further moved the recommended distance and direction.

In one or more embodiments, a mesh node signal optimization system for determining the optimal location of a mesh node in a Wi-Fi network to optimize signal throughput strength to Wi-Fi enabled devices in one or more user hotspots is disclosed. The mesh node signal optimization system includes one or more processors and a memory device that stores a set of computer instructions. When the computer instructions are executed by the one or more processors, it causes the satellite signal optimization system to: obtain information regarding a number and location of one or more user hotspots; obtain information regarding an initial position of a mesh node with respect to the one or more user hotspots; perform benchmark throughput tests with one or more Wi-Fi enabled devices in the one or more user hotspots, wherein the benchmark throughput tests of the one or more Wi-Fi enabled devices are performed at a plurality of known distances from the mesh node by moving the mesh node between consecutive throughput tests; recommend moving the mesh node a distance and direction to improve benchmark throughput test results with the one or more Wi-Fi enabled devices in the one or more user hotspots; display a mapping of throughput test data at all of the one or more user hotspots with respect to various testing positions of the mesh node; and determine an optimal position of the mesh node for throughput signal strength in the one or more user hotspots.

In some embodiments of the mesh node signal optimization system, the memory further includes computer-executable instructions that further cause the processor to identify a size and shape of each user hotspot in the one or more user hotspots. In another aspect of some embodiments of the mesh node signal optimization system, the memory further includes computer-executable instructions that further cause the processor to perform one or more of: obtain Bluetooth readings to assist with mesh node placement, obtain Global Positioning System (GPS) readings to assist with mesh node placement, and obtain local positioning system readings to assist with mesh node placement.

In still another aspect of some embodiments, the mesh node signal optimization system recommends router movement for signal strength optimization with respect to the one or more user hotspots. In yet another aspect of some embodiments, the mesh node signal optimization system recommends signal strength optimization for a highest minimum throughput across all of the one or more user hotspots. Further, in another aspect of some embodiments, the mesh node signal optimization system receives information regarding priority levels of the one or more user hotspots, and recommends signal strength optimization for peak throughput at the user hotspot with a highest priority level.

In one or more embodiments of the mesh node signal optimization system, the mapping of throughput test data with respect to various locations of the mesh node is a signal throughput strength heat map. In still another aspect of some embodiments, the mesh node signal optimization system recommends that an additional mesh node be added to maintain a highest minimum throughput across all of the one or more user hotspots, and recommends an optimal location of the additional mesh node to be added. In still another aspect of some embodiments of the mesh node signal optimization system, the memory further includes computer-executable instructions that further cause the processor to: recommend further moving the mesh node a distance and direction to improve benchmark throughput test results with the one or more Wi-Fi enabled devices in the one or more user hotspots; and additionally, reperform the benchmark throughput tests of the one or more Wi-Fi enabled devices in the one or more user hotspots with the mesh node further moved the recommended distance and direction.

These features with other technological improvements, which will become subsequently apparent, reside in the details of construction and operation as more fully described hereafter and claimed, reference being had to the accompanying drawings forming a part hereof.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates a mesh node reception system with one or more Wi-Fi mesh nodes that transmits to a Wi-Fi router.

FIG. 2 illustrates transmission of mesh node reception system with a Wi-Fi router in a first location and a Wi-Fi mesh node in a first location, in accordance with embodiments described herein.

FIG. 3 illustrates transmission of mesh node reception system with a Wi-Fi router in a first location and a Wi-Fi mesh node in a second location, in accordance with embodiments described herein.

FIG. 4 illustrates transmission of mesh node reception system with a Wi-Fi router in a second location and a Wi-Fi mesh node in a second location, in accordance with embodiments described herein.

FIG. 5 illustrates transmission of mesh node reception system with a Wi-Fi router in a first location, a first Wi-Fi mesh node in a first location, and a second Wi-Fi mesh node in a first location, in accordance with embodiments described herein.

FIG. 6 illustrates transmission of mesh node reception system with a Wi-Fi router in a second location, a first Wi-Fi mesh node in a second location, and a second Wi-Fi mesh node in a second location, in accordance with embodiments described herein.

FIG. 7 illustrates a logical flow diagram of a mesh node reception system with one or more Wi-Fi mesh nodes that transmits to a Wi-Fi router in accordance with embodiments described herein.

FIG. 8 shows a system block diagram that depicts one implementation of computing systems for employing embodiments described herein.

### DETAILED DESCRIPTION

Persons of ordinary skill in the art will understand that the present disclosure is illustrative only and not in any way limiting. Other embodiments and various combinations of the presently disclosed system and method readily suggest themselves to such skilled persons having the assistance of this disclosure.

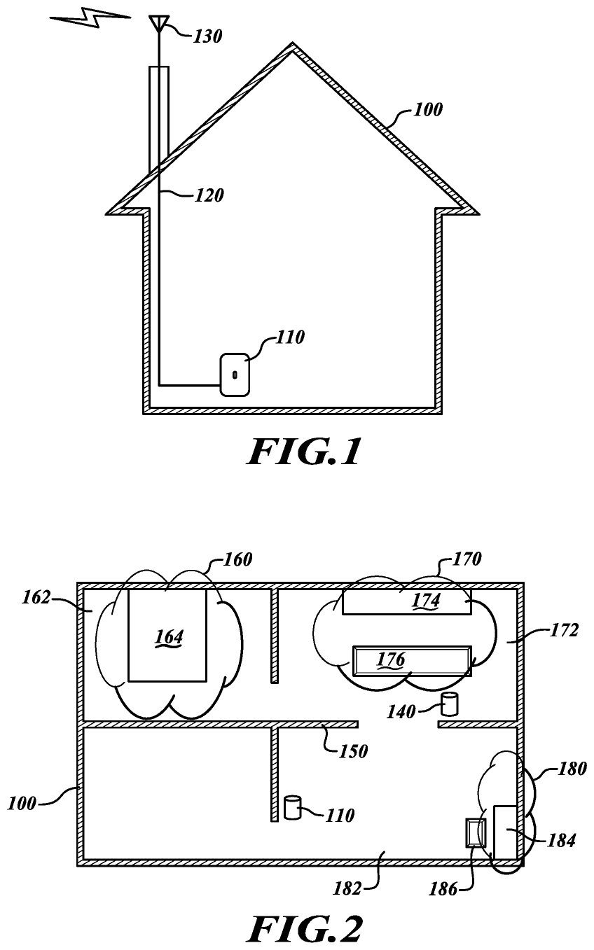

Each of the features and teachings disclosed herein can be utilized separately or in conjunction with other features and teachings to provide a mesh node signal optimization system for determining the optimal location of a mesh node in a Wi-Fi network to optimize signal throughput strength to Wi-Fi enabled devices in one or more user hotspots. Representative examples utilizing many of these additional features and teachings, both separately and in combination, are described in further detail with reference to attached FIGS. 1-8. This detailed description is intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm, as described herein, is a sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” “configuring,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

Referring now to FIGS. 1-6, one embodiment of a system for optimal location determination of a mesh node in a Wi-Fi network is shown. In this embodiment, the Wi-Fi network is located in a user's house 100, as shown in FIG. 1. The main router 110 is connected to a data line 120 that runs into the user's house 100. The data line 120 may send and receive data via a wireless transmitter/receiver 130 or a wired connection to the Internet (not shown). The Wi-Fi mesh network includes a main router 110 and one or more mesh nodes 140 (shown in FIGS. 2-6).

Referring now to FIGS. 2-4, the user's house 100 contains the system for optimal location determination of a mesh node in a Wi-Fi mesh network. The user's house 100 has walls 150 that separate its interior space into rooms that include a bedroom 162, a living room 172, and an office 182. The Wi-Fi mesh network is configured to provide Wi-Fi signal coverage to hotspots 160, 170, and 180, in the bedroom 162, the living room 172, and the office 182, respectively, of the user's house 100. As defined herein, a hotspot (e.g., 160, 170, and 180) refers to a desired Wi-Fi coverage area. The bedroom 162 includes a hotspot 160 that is shaped and sized to cover the primary usage area of the bedroom 162. In the embodiments shown in FIGS. 2-4, the hotspot 160 in the bedroom 162 is configured to primarily cover the user's bed 164, which is where the user operates his or her smartphone, laptop computer, and other mobile Wi-Fi enabled devices. Additionally, in the embodiments shown in FIGS. 2-4, the hotspot 170 in the living room 172 is configured to primarily cover the user's Wi-Fi enabled television 174 and the couch 176, which is where the user (and his or her guests) operate their smartphones, laptop computers, and other mobile Wi-Fi enabled devices. Moreover, in the embodiments shown in FIGS. 2-4, the hotspot 180 in the office 182 is configured to primarily cover the user's desk 184 and the chair 186, which is where the user operates his or her computer, smartphone, and other mobile Wi-Fi enabled devices.

In one or more embodiments of the system for optimal location determination of a mesh node in a Wi-Fi network, information is received by the system regarding a number and location of the user hotspots 160, 170, and 180. In one embodiment, this information may be sent to the system by a user via a mobile Wi-Fi enabled smartphones and laptop computers. For example, the user may send raw Wi-Fi measurement data to the system or may even use an application to draw the hotspot shapes and send this shape data to the system. In another embodiment, this information may be automatically collected from a user, via a mobile Wi-Fi enabled smartphones and laptop computers, as the user moves around each hotspot in the hotspots 160, 170, and 180. In some embodiments, the user connects to the mesh node location optimization system via a Wi-Fi enabled mobile device (e.g., smartphone, laptop computer, etc.) to send and receive information with the mesh node location optimization system. A hotspot is an area of high interest to the user within the Wi-Fi mesh network due to the user's desire for high usage of Wi-Fi enabled devices within that hotspot area.

In another operation of the method, a size and shape of each hotspot in the hotspots 160, 170, and 180, are received by the mesh node location optimization system. As described above, the information is typically sent from a Wi-Fi enabled mobile device (e.g., smartphone, laptop computer, etc.). Hotspots may have different shapes and sizes depending on the desired Wi-Fi usage within the hotspot area. For example, a hotspot that is configured to cover a Wi-Fi enabled television set likely will be smaller since the Wi-Fi enabled television is stationary. In contrast, a hotspot that is configured to cover multiple Wi-Fi enabled smartphones and laptop computers (or multiple Wi-Fi enabled smartphone and laptop computer usage areas), perhaps in an office or bedroom, may have a larger coverage area.

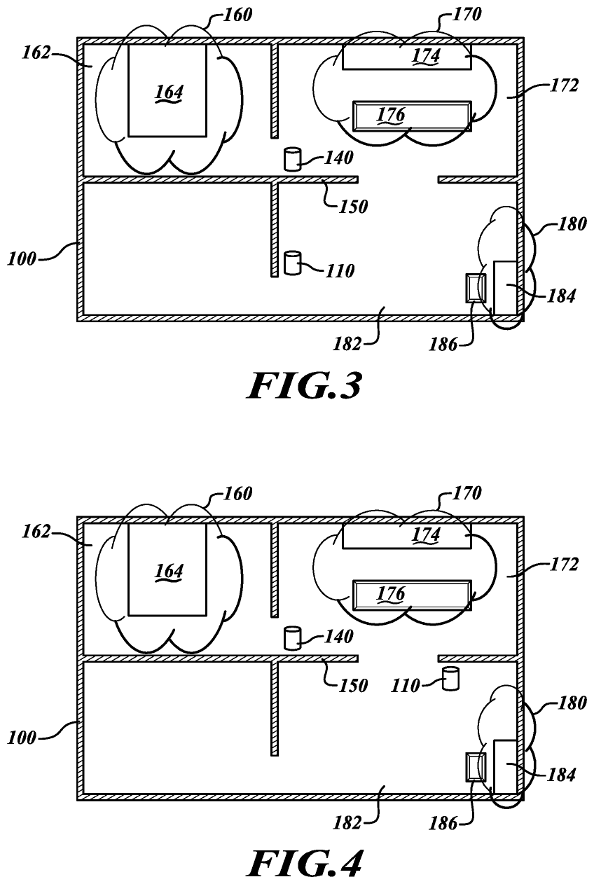

In still another operation of the mesh node location optimization method, information is received regarding an initial position of the main router 110 with respect to the hotspots 160 170, and 180. Again, the information is typically sent from a Wi-Fi enabled mobile device (e.g., smartphone, laptop computer, etc.). As shown in FIGS. 2 and 3, the main router 110 is positioned in the office 182, towards the left side of the office. Notably, the main router 110 is positioned near the center of the entire house 100. Significantly, with the main router 110 in the position shown in FIGS. 2 and 3, the main router 110 has a clear line-of-sight view of all of hotspot 180 in the office 182 and some of hotspot 170 in the living room 172. The main router 110 does not have a clear line-of-sight view of hotspot 160, but depending on the composition and thickness of the walls 150, the main router 110 may be able to communicate with hotspot 160 in the bedroom 162. The frequency of the Wi-Fi signal being used (e.g., 2.4, 5.0, etc.) will also affect the main router's ability to communicate with hotspot 160 in the bedroom 162.

In still another operation of the mesh node location optimization method, information is received regarding an initial position of the mesh node 140 with respect to the hotspots 160, 170, and 180. Once again, the information is typically sent from a Wi-Fi enabled mobile device (e.g., smartphone, laptop computer, etc.). As shown in FIG. 2, the mesh node 140 is positioned in the living room 172, towards the right side of the living room. As shown in FIG. 3, the mesh node 140 is positioned in towards the left side of the living room, near the entrance into the bedroom 162. The initial position of the mesh node 140 may be halfway between the main router 110 and the relevant hotspots 170 and 180. This position may be adjusted for line-of-sight considerations, adjusted for signal-blocking obstacles, or both. As shown in FIG. 4, the mesh node 140 remains in the same position as in FIG. 3 (positioned in towards the left side of the living room, near the entrance into the bedroom 162), while the main router 110 remains in the office 182, but is moved from the left side of the office to the right side of the office. In this position, the main router 110 is slightly farther away from the mesh node 140, but has a more direct line-of-sight with the mesh node 140. This will be a technological improvement in some embodiments, depending on the thickness and material that composes the walls 150.

Referring now to another operation of the mesh node location optimization method, benchmark throughput tests are performed with one or more Wi-Fi enabled devices (e.g., smartphone, laptop computer, television 174, etc.) in the one or more user hotspots 160, 170, and 180. Specifically, the benchmark throughput tests of the one or more Wi-Fi enabled devices are performed at a plurality of known distances (e.g., 2 ft, 4 ft, 6 ft, 8 ft, 10 ft, 12 ft, 14 ft, 16 ft, 18 ft, and 20 ft) from the mesh node 140 by moving the mesh node 140 between consecutive throughput tests. Specifically, the Wi-Fi devices stay in the same position within a hotspot and the mesh node 140 is moved between the known distances. If the user's house 100 only has identified a single hotspot 160, then the mesh node 140 may be moved along a line between the router 110 and the single hotspot 160. However, if the user's house 100 has identified two hotspots 160 and 170, then the mesh node 140 may be firstly moved along a line between the router 110 and the first hotspot 160, secondly moved along a line between the router 110 and the second hotspot 170, and thirdly moved along a combination route between the router 110 and the first and second hotspots 160 and 170. In another aspect of some embodiments, the benchmark throughput tests of the one or more Wi-Fi enabled devices are performed at a plurality of known distances (e.g., 2 ft, 4 ft, 6 ft, 8 ft, 10 ft, 12 ft, 14 ft, 16 ft, 18 ft, and 20 ft) from the router 110 by moving the router 110 between consecutive throughput tests.

In yet another embodiment that has identified three hotspots 160, 170, and 180, the mesh node 140 may be firstly moved along a line between the router 110 and the first hotspot 160, secondly moved along a line between the router 110 and the second hotspot 170, thirdly moved along a line between the router 110 and the third hotspot 180, and fourthly moved along one or more combination routes between the router 110 and the first, second, and third hotspots 160, 170, and 180. Notably, in some embodiments, the mesh node location optimization method enables the user to input hotspot priority information into the system. For example, in one embodiment, the system may be configured to receive information from the user that hotspot 170 is the highest priority, hotspot 180 is the second highest priority, and hotspot 160 is the lowest priority. In another embodiment, the system may be configured to receive information from the user that hotspot 180 is the highest priority, hotspot 170 is the second highest priority, and hotspot 160 is the lowest priority. Accordingly, the system recommends signal strength optimization for peak throughput at the user hotspot with a highest priority level. Notably, the one or more combination routes between the main router 110 and the first, second, and third hotspots 160, 170, and 180, are affected by the prioritizing of the hotspots 160, 170, and 180 by the user.

In still another operation of the mesh node location optimization method, benchmark throughput tests are performed on the mesh node 140 to the main router 110 over known distances (e.g., 2 ft, 4 ft, 6 ft, 8 ft, 10 ft, 12 ft, 14 ft, 16 ft, 18 ft, and 20 ft). The mesh node 140 cannot provide better signal reception than it receives from the main router 110, so benchmark throughput testing is useful to ensure that the mesh node 140 is not placed too far from the main router 110. Additionally, benchmark throughput testing is useful to ensure that the mesh node 140 is not placed in a location with obstacle concerns with respect to the main router 110.

Continuing, in a further operation of the mesh node location optimization method, the system recommends moving the mesh node 140 a distance and direction from the router 110 to improve benchmark throughput test results with the one or more Wi-Fi enabled devices (e.g., smartphone, laptop computer, television 174, etc.) in the one or more user hotspots (e.g., 160, 170, and 180). In one embodiment, the mesh node location optimization system recommends moving the mesh node 140 in directions that include left or right, and forward or backward, from a top map view of the user's house 100. In another embodiment, the mesh node location optimization system recommends moving the mesh node 140 in directions that include East, West, North, and South. In still another embodiment, the mesh node location optimization system recommends moving the mesh node 140 in directions that include a latitude and a longitude. In yet another embodiment, the mesh node location optimization system recommends moving the mesh node 140 in a horizontal distance and a vertical distance, from a top map view of the user's house 100.

In some embodiments, the mesh node location optimization system is also configured to compensate for available power supply to mesh node 140. Since mesh nodes 140 are typically powered devices that connect directly to electrical outlets, the mesh node location optimization system is configured to compensate for available power locations in some embodiments.

Additionally, in some embodiments, the mesh node location optimization system is also configured to compensate for non-Wi-Fi enabled devices in the user's house 100 that require an Internet connection, for example, a desktop computer that is not Wi-Fi enabled. Since many mesh nodes 140 typically provide a hard wire Ethernet port (or other wired data port), the mesh node location optimization system is configured to compensate for non-Wi-Fi enabled devices in the user's house 100 in some embodiments.

Regarding another operation of the mesh node location optimization method, the system reperforms benchmark throughput tests of the one or more Wi-Fi enabled devices (e.g., smartphone, laptop computer, television 174, etc.) in the one or more user hotspots (e.g., 160, 170, and 180) after the mesh node 140 has been moved the recommended distances and directions, as recommended above. This combination of recommending movement of the mesh node 140 a distance and direction to improve benchmark throughput test results of the one or more Wi-Fi enabled devices in the one or more user hotspots 160, 170, and 180, and reperforming the benchmark throughput tests of the one or more Wi-Fi enabled devices in the one or more user hotspots 160, 170, and 180 after the mesh node 140 has been moved the recommended distances and directions, may be repeated as necessary.

Additionally, in another operation of the mesh node location optimization method, the system displays a mapping of throughput test data at all of the one or more hotspots 160, 170, and 180 with respect to various testing positions of the mesh node 140. In some such embodiments, the system draws optimal signal strength lines in the user's house 100 using the throughput test data map. In another aspect of some such embodiments, the system mapping of throughput test data with respect to various locations of the mesh node 140 is a signal throughput strength heat map. Such optimal signal strength lines in the user's house 100 may compensate for prioritizing of the hotspots 160, 170, and 180 in embodiments of the mesh node location optimization method that includes hotspot prioritization. Furthermore, in another operation of the mesh node location optimization method, the system notifies the user of an optimal position for the mesh node 140 for throughput signal strength in the one or more user hotspots 160, 170, and 180. Again, the notification is typically sent from the system to a Wi-Fi enabled mobile device (e.g., smartphone, laptop computer, etc.).

In another aspect of the mesh node location optimization system, the system also obtains Bluetooth signals (in addition to the Wi-Fi signals) to assist with the placement of the mesh node 140. In still another aspect of the mesh node location optimization system, the system also obtains Global Positioning System (GPS) signals (in addition to the Wi-Fi signals) to assist with the placement of the mesh node 140. In yet another aspect of the mesh node location optimization system, the system also obtains local positioning system signals (in addition to the Wi-Fi signals) to assist with the placement of the mesh node 140.

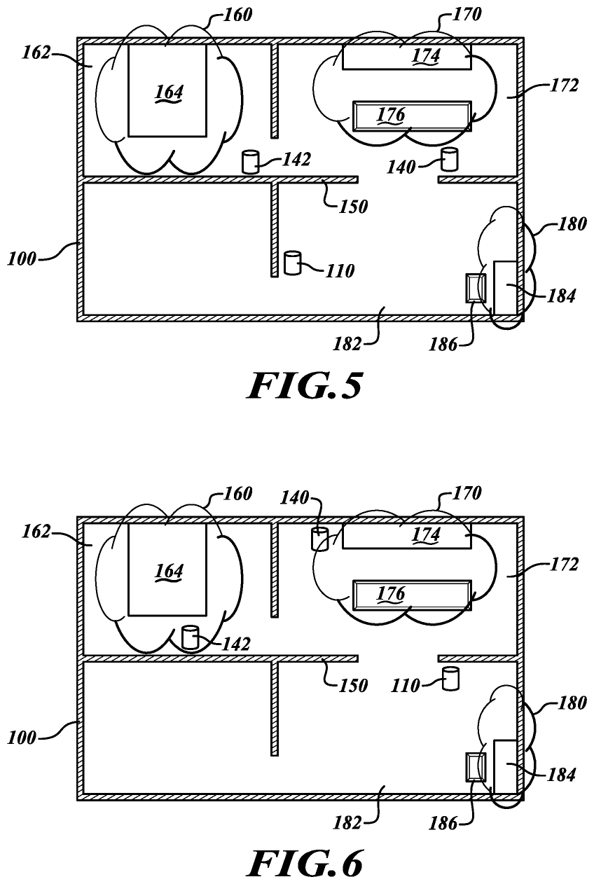

Referring now to FIGS. 5 and 6, some embodiments of a multi-mesh node version of the mesh node location optimization system are shown. In some such multi-mesh node embodiments, the system determines that a minimum threshold of Wi-Fi signal reception is not going to be provided by the main router 110 and the single mesh node 140 to the Wi-Fi enabled devices in the hotspots 160, 170, and 180, no matter where the main router 110 and the mesh node 140 are placed. In some such embodiments, the mesh node location optimization system recommends the addition of a second mesh node 142, as well as providing recommended placements of the first mesh node 140 and the second mesh node 142, based on the results from the first benchmark testing and node movements.

For example, in the embodiment shown in FIG. 5, the main router 110 is placed in a first position towards the left side of the office 182 where it provides Wi-Fi signal to the hotspot 180, the first mesh node 140 is placed in a first position towards the right side of the living room 172 where it provides Wi-Fi signal to the hotspot 170, and the second mesh node 142 is placed in a first position towards the right side of the bedroom 162 where it provides Wi-Fi signal to the hotspot 160. The addition of the second mesh node 142 and the positioning of the second mesh node 142 is recommended to the user by the mesh node location optimization system. Continuing, the mesh node location optimization system then further recommends moving each of the first and second mesh nodes 140 and 142 a distance and direction to improve benchmark throughput test results with the one or more Wi-Fi enabled devices in the hotspots 160, 170, and 180.

Additionally, the mesh node location optimization system may then reperform the benchmark throughput tests of the one or more Wi-Fi enabled devices in the hotspots 160, 170, and 180 with the first and second mesh nodes 140 and 142 further moved the recommended distances and directions. This is shown in the embodiment of FIG. 6, where the main router 110 is placed in a second position towards the right side of the office 182 where it provides Wi-Fi signal to the hotspot 180, the first mesh node 140 is placed in a second position towards the top left of the living room 172 where it provides Wi-Fi signal to the hotspot 170, and the second mesh node 142 is placed in a second position towards the center bottom of the bedroom 162 where it provides Wi-Fi signal to the hotspot 160.

Typically, the mesh node location optimization system first runs benchmark throughput tests with known Wi-Fi enabled devices (e.g., smartphone, laptop computer, etc.) that have known Wi-Fi reception capabilities and characteristics, as well as potentially known peculiarities. After this initial testing has been completed, new testing may be performed with new Wi-Fi enabled devices. Differences between the known Wi-Fi enabled devices and new Wi-Fi enabled devices may then be analyzed. Finally, the mesh node location optimization system may then rerun system optimization operations described above with new Wi-Fi enabled devices that will be used in the Wi-Fi mesh network in the user's house 100.

In some embodiments of the mesh node location optimization method, the system recommends moving the main router 110 to improve benchmark throughput test results with the one or more Wi-Fi enabled devices (e.g., smartphone, laptop computer, television 174, etc.) in the one or more user hotspots (e.g., 160, 170, and 180). In one embodiment, the mesh node location optimization system recommends moving the main router 110 in directions that include left or right, and forward or backward, from a top map view of the user's house 100. In another embodiment, the mesh node location optimization system recommends moving the main router 110 in directions that include East, West, North, and South. In still another embodiment, the mesh node location optimization system recommends moving the main router 110 in directions that include a latitude and a longitude. In yet another embodiment, the mesh node location optimization system recommends moving the main router 110 in a horizontal distance and a vertical distance, from a top map view of the user's house 100.

In some embodiments of the mesh node location optimization method, the system recommends moving one or more of the hotspots 160, 170, or 180 to improve benchmark throughput test results with the one or more Wi-Fi enabled devices (e.g., smartphone, laptop computer, television 174, etc.). In some embodiments, moving one or more of the hotspots will not be practical, but in other embodiments it may be practical. In one embodiment, the mesh node location optimization system recommends moving one or more of the hotspots 160, 170, or 180 in directions that include left or right, and forward or backward, from a top map view of the user's house 100. In another embodiment, the mesh node location optimization system recommends moving one or more of the hotspots 160, 170, or 180 in directions that include East, West, North, and South. In still another embodiment, the mesh node location optimization system recommends moving one or more of the hotspots 160, 170, or 180 in directions that include a latitude and a longitude. In yet another embodiment, the mesh node location optimization system recommends moving one or more of the hotspots 160, 170, or 180 in a horizontal distance and a vertical distance, from a top map view of the user's house 100.

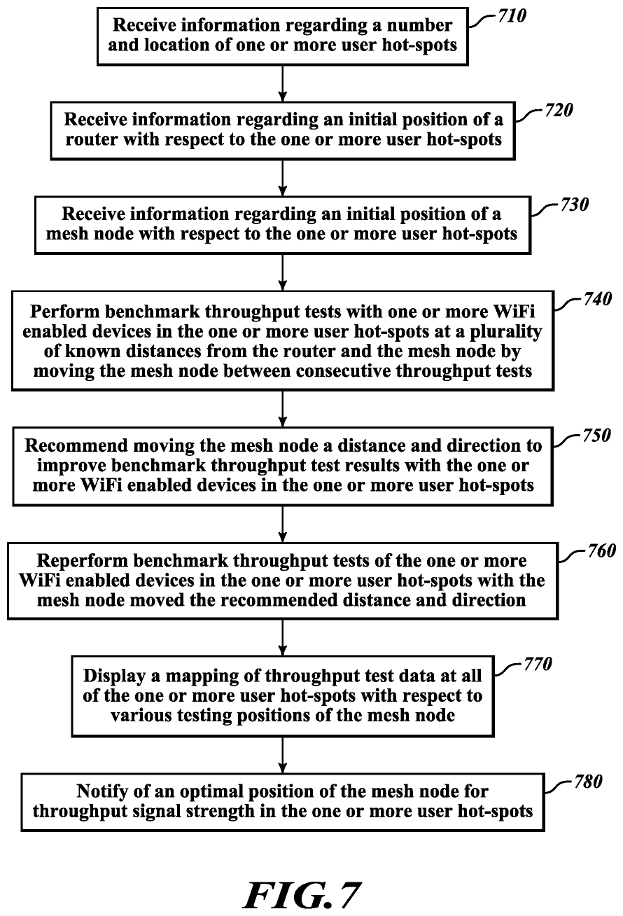

FIG. 7 is a logic diagram showing a method for optimal location identification of mesh nodes in a mesh network. As shown in FIG. 7, at operation 710, the method includes receiving information regarding a number and location of one or more user hotspots. At operation 720, the method includes receiving information regarding an initial position of a router with respect to the one or more user hotspots. At operation 730, the method includes receiving information regarding an initial position of a mesh node with respect to the one or more user hotspots. At operation 740, the method includes performing benchmark throughput tests with one or more Wi-Fi enabled devices in the one or more user hotspots at a plurality of known distances from the mesh node by moving the mesh node between consecutive throughput tests. At operation 750, the method includes recommending moving the mesh node a distance and direction to improve benchmark throughput test results with the one or more Wi-Fi enabled devices in the one or more user hotspots. At operation 760, the method includes reperforming benchmark throughput tests of the one or more Wi-Fi enabled devices in the one or more user hotspots with the mesh node moved the recommended distance and direction. At operation 770, the method includes displaying a mapping of throughput test data at all of the one or more user hotspots with respect to various testing positions of the mesh node. At operation 780, the method includes notifying of an optimal position of the mesh node for throughput signal strength in the one or more user hotspots.

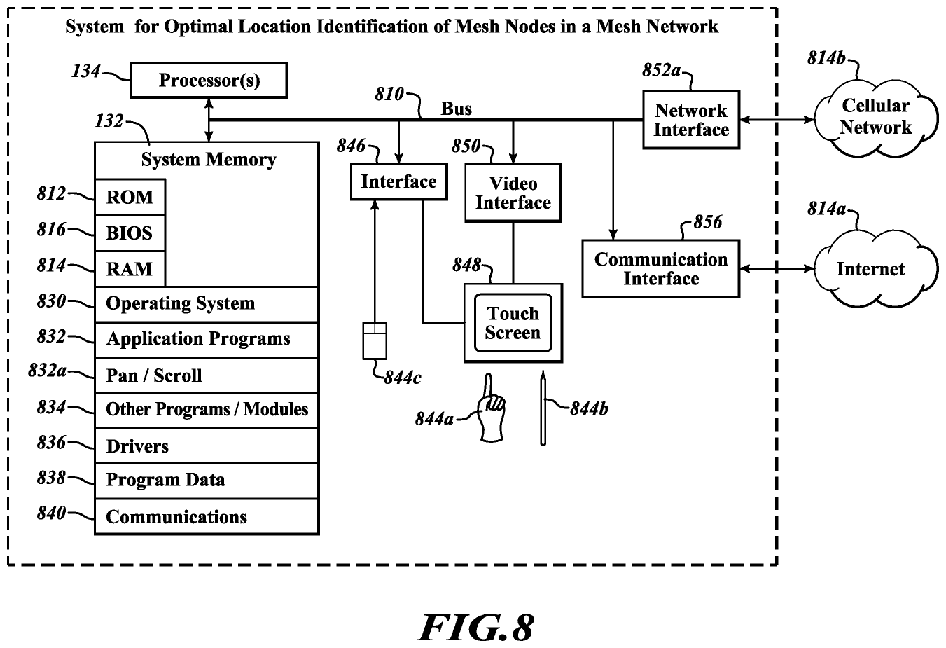

FIG. 8 shows a processor-based device suitable for implementing the System for Optimal Location Identification of Mesh Nodes in a Mesh Network. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (PCs), network PCs, minicomputers, mainframe computers, and the like.

In the system for stereo camera vision system, the processor-based device may include one or more processors 134, a system memory 132 and a system bus 810 that couples various system components including the system memory 132 to the processor(s) 134. The processor-based device will, at times, be referred to in the singular herein, but this is not intended to limit the implementations to a single system, since in certain implementations, there will be more than one system or other networked computing devices involved. Non-limiting examples of commercially available systems include, but are not limited to, ARM processors from a variety of manufacturers, Core microprocessors from Intel Corporation, U.S.A., PowerPC microprocessor from IBM, Sparc microprocessors from Sun Microsystems, Inc., PA-RISC series microprocessors from Hewlett-Packard Company, and 68xxx series microprocessors from Motorola Corporation. The system memory 132 may be located on premises or it may be cloud based.

The processor(s) 134 in the processor-based devices of the system for stereo camera vision system may be any logic processing unit, such as one or more central processing units (CPUs), microprocessors, digital signal processors (DSPs), application-specific integrated circuits (ASICs), field programmable gate arrays (FPGAs), and the like. Unless described otherwise, the construction and operation of the various blocks shown in FIG. 5 are of conventional design. As a result, such blocks need not be described in further detail herein, as they will be understood by those skilled in the relevant art.

The system bus 810 in the processor-based devices of the system for stereo camera vision system can employ any known bus structures or architectures, including a memory bus with a memory controller, a peripheral bus, and a local bus. The system memory 132 includes read-only memory (ROM) 812 and random access memory (RAM) 814. A basic input/output system (BIOS) 816, which can form part of the ROM 812, contains basic routines that help transfer information between elements within the processor-based device, such as during start-up. Some implementations may employ separate buses for data, instructions and power.

The processor-based device of the system for stereo camera vision system may also include one or more solid state memories; for instance, a flash memory or solid state drive (SSD), which provides nonvolatile storage of computer-readable instructions, data structures, program modules and other data for the processor-based device. Although not depicted, the processor-based device can employ other nontransitory computer- or processor-readable media, for example, a hard disk drive, an optical disk drive, or a memory card media drive.

Program modules in the processor-based devices of the system for stereo camera vision system can be stored in the system memory 132, such as an operating system 830, one or more application programs 832, other programs or modules 834, drivers 836 and program data 838.

The application programs 832 may, for example, include panning/scrolling logic 832a. Such panning/scrolling logic may include, but is not limited to, logic that determines when and/or where a pointer (e.g., finger, stylus, cursor) enters a user interface element that includes a region having a central portion and at least one margin. Such panning/scrolling logic may include, but is not limited to, logic that determines a direction and a rate at which at least one element of the user interface element should appear to move, and causes updating of a display to cause the at least one element to appear to move in the determined direction at the determined rate. The panning/scrolling logic 832a may, for example, be stored as one or more executable instructions. The panning/scrolling logic 832a may include processor and/or machine executable logic or instructions to generate user interface objects using data that characterizes movement of a pointer, for example, data from a touch-sensitive display or from a computer mouse or trackball, or another user interface device.

The system memory 132 in the processor-based devices of the system for stereo camera vision system may also include communications programs 840, for example, a server and/or a Web client or browser for permitting the processor-based device to access and exchange data with other systems such as user computing systems, websites on the Internet, corporate intranets, or other networks as described below. The communications program 840 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 8 as being stored in the system memory 132, operating system 830, application programs 832, other programs/modules 834, drivers 836, program data 838 and server and/or browser can be stored on any other of a large variety of non-transitory processor-readable media (e.g., hard disk drive, optical disk drive, SSD and/or flash memory).

A user of a processor-based device in the system for stereo camera vision system can enter commands and information via a pointer, for example, through input devices such as a touch screen 848 via a finger 844a, stylus 844b, or via a computer mouse or trackball 844c which controls a cursor. Other input devices can include a microphone, joystick, game pad, tablet, scanner, biometric scanning device, and the like. These and other input devices (i.e., I/O devices) are connected to the processor(s) 134 through an interface 846 such as a touch-screen controller and/or a universal serial bus (USB) interface that couples user input to the system bus 810, although other interfaces such as a parallel port, a game port or a wireless interface or a serial port may be used. The touch screen 848 can be coupled to the system bus 810 via a video interface 850, such as a video adapter to receive image data or image information for display via the touch screen 848. Although not shown, the processor-based device can include other output devices, such as speakers, vibrator, haptic actuator or haptic engine, and the like.

The processor-based devices of the system for stereo camera vision system operate in a networked environment using one or more of the logical connections to communicate with one or more remote computers, servers and/or devices via one or more communications channels, for example, one or more networks 814a, 814b. These logical connections may facilitate any known method of permitting computers to communicate, such as through one or more LANs and/or WANs, such as the Internet, and/or cellular communication networks. Such networking environments are well known in wired and wireless enterprise-wide computer networks, intranets, extranets, the Internet, and other types of communication networks including telecommunication networks, cellular networks, paging networks, and other mobile networks.

When used in a networking environment, the processor-based devices of the system for stereo camera vision system may include one or more network, wired or wireless communications interfaces 852a, 856 (e.g., network interface controllers, cellular radios, Wi-Fi radios, Bluetooth radios) for establishing communications over the network, for instance, the Internet 814a or cellular network 814b.

In a networked environment, program modules, application programs, or data, or portions thereof, can be stored in a server computing system (not shown). Those skilled in the relevant art will recognize that the network connections shown in FIG. 5 are only some examples of ways of establishing communications between computers, and other connections may be used, including wirelessly.

For convenience, the processor(s) 134, system memory 132, and network and communications interfaces 852a, 856 are illustrated as communicably coupled to each other via the system bus 810, thereby providing connectivity between the above-described components. In alternative implementations of the processor-based device, the above-described components may be communicably coupled in a different manner than illustrated in FIG. 5. For example, one or more of the above-described components may be directly coupled to other components, or may be coupled to each other, via intermediary components (not shown). In some implementations, system bus 810 is omitted, and the components are coupled directly to each other using suitable connections.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), one or more communicative link(s) through one or more wireless communication protocol(s), and/or optical pathways (e.g., optical fiber), and exemplary communicative couplings include, but are not limited to, electrical couplings, magnetic couplings, wireless couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” “to, at least, provide,” “to, at least, transmit,” and so on.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied to other portable and/or wearable electronic devices, not necessarily the exemplary wearable electronic devices generally described above.

For instance, the foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs executed by one or more computers (e.g., as one or more programs running on one or more computer systems), as one or more programs executed by one or more controllers (e.g., microcontrollers), as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by, or in connection with, any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by, or in connection with, the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or flash memory), a portable compact disc read-only memory (CD-ROM), digital tape, and other non-transitory media.

Operations of processes described herein can be performed in any suitable order unless otherwise indicated herein or otherwise clearly contradicted by context. The processes described herein (or variations and/or combinations thereof) are performed under the control of one or more computer systems configured with executable instructions and are implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals.

In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lacks all of the code while the multiple non-transitory computer-readable storage media collectively store all of the code. In an embodiment, the executable instructions are executed such that different instructions are executed by different processors—for example, a non-transitory computer-readable storage medium stores instructions and a main CPU executes some of the instructions while a graphics processor unit executes other instructions. In an embodiment, different components of a computer system have separate processors, and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure. All references, including publications, patent applications, and patents, cited herein are hereby incorporated by reference to the same extent as if each reference were individually and specifically indicated to be incorporated by reference and were set forth in its entirety herein.

1. A system for optimal location determination of a mesh node in a Wi-Fi network, the system comprising:
a memory that stores computer-executable instructions; and
a processor that executes the computer-executable instructions and causes the processor to:
receive information regarding a number and location of one or more user hotspots;
receive information regarding an initial position of a router with respect to the one or more user hotspots;
receive information regarding an initial position of a mesh node with respect to the one or more user hotspots;
perform benchmark throughput tests with one or more Wi-Fi enabled devices in at least one of the one or more user hotspots, wherein the benchmark throughput tests of the one or more Wi-Fi enabled devices are performed at a plurality of known distances from the mesh node by moving the mesh node between consecutive throughput tests;
recommend moving the mesh node a distance and direction to improve benchmark throughput test results with the one or more Wi-Fi enabled devices in at least one of the one or more user hotspots;
reperform the benchmark throughput tests of the one or more Wi-Fi enabled devices in at least one of the one or more user hotspots with the mesh node moved the recommended distance and direction;
display a mapping of throughput test data at all of the one or more user hotspots with respect to various testing positions of the mesh node; and
notify of an optimal position of the mesh node for throughput signal strength in the one or more user hotspots based on the throughput test data.

2. The system of claim 1, wherein the memory further includes computer-executable instructions that further cause the processor to identify a size and shape of each user hotspot in the one or more user hotspots.

3. The system of claim 1, wherein the memory further includes computer-executable instructions that further cause the processor to perform one or more of: obtain Bluetooth readings to assist with mesh node placement, obtain Global Positioning System (GPS) readings to assist with mesh node placement, and obtain local positioning system readings to assist with mesh node placement.

4. The system of claim 1, wherein the system recommends router movement for signal strength optimization with respect to the one or more user hotspots.

5. The system of claim 1, wherein the system recommends signal strength optimization for a highest minimum throughput across all of the one or more user hotspots.

6. The system of claim 1, wherein the system receives information regarding priority levels of the one or more user hotspots, and wherein the system recommends signal strength optimization for peak throughput at the user hotspot with a highest priority level.

7. The system of claim 1, wherein the mapping of throughput test data with respect to various locations of the mesh node is a signal throughput strength heat map.

8. The system of claim 1, wherein the system recommends that an additional mesh node be added to maintain a highest minimum throughput across all of the one or more user hotspots, and recommends an optimal location of the additional mesh node to be added.

9. The system of claim 1, wherein the memory further includes computer-executable instructions that further cause the processor to:
recommend further moving the mesh node a distance and direction to improve benchmark throughput test results with the one or more Wi-Fi enabled devices in the one or more user hotspots; and
additionally, reperform the benchmark throughput tests of the one or more Wi-Fi enabled devices in the one or more user hotspots with the mesh node further moved the recommended distance and direction.

10. A method of optimal location identification of a mesh node in a Wi-Fi network, the method comprising:
receiving information regarding a number and location of one or more user hotspots;
receiving information regarding an initial position of a router with respect to the one or more user hotspots;
receiving information regarding an initial position of a mesh node with respect to the one or more user hotspots;
performing benchmark throughput tests with one or more Wi-Fi enabled devices in at least one of the one or more user hotspots, wherein the benchmark throughput tests of the one or more Wi-Fi enabled devices are performed at a plurality of known distances from the mesh node by moving the mesh node between consecutive throughput tests;
recommending moving the mesh node a distance and direction to improve benchmark throughput test results with the one or more Wi-Fi enabled devices in at least one of the one or more user hotspots;
reperforming the benchmark throughput tests of the one or more Wi-Fi enabled devices in at least one of the one or more user hotspots with the mesh node moved the recommended distance and direction; and
notifying of an optimal position of the mesh node for throughput signal strength in the one or more user hotspots based on the benchmark throughput test results.

11. The method of claim 10, further comprising: obtaining a size and shape of each user hotspot in the one or more user hotspots.

12. The method of claim 10, further comprising one or more of:
obtaining Bluetooth readings to assist with mesh node placement;
obtaining Global Positioning System (GPS) readings to assist with mesh node placement; and
obtaining local positioning system readings to assist with mesh node placement.

13. The method of claim 10, further comprising: recommending router movement for signal strength optimization with respect to the one or more user hotspots.

14. The method of claim 10, further comprising: recommending signal strength optimization for a highest minimum throughput across all of the one or more user hotspots.

15. The method of claim 10, further comprising:
receiving information regarding priority levels of the one or more user hotspots; and
recommending signal strength optimization for peak throughput at the user hotspot with a highest priority level.

16. The method of claim 10, wherein the mapping of throughput test data with respect to various locations of the mesh node is a signal throughput strength heat map.

17. The method of claim 10, further comprising: recommending that an additional mesh node be added to maintain a highest minimum throughput across all of the one or more user hotspots, and recommending an optimal location of the additional mesh node to be added.

18. The method of claim 10, further comprising:
recommending further moving the mesh node a distance and direction to improve benchmark throughput test results with the one or more Wi-Fi enabled devices in the one or more user hotspots; and
additionally, reperforming benchmark throughput tests of the one or more Wi-Fi enabled devices in the one or more user hotspots with the mesh node further moved the recommended distance and direction.

19. A system for optimal location identification of mesh nodes in a Wi-Fi network, the system comprising:
a memory that stores computer-executable instructions; and
a processor that executes the computer-executable instructions and causes the processor to:
obtain information regarding a number and location of one or more user hotspots;
obtain information regarding an initial position of a mesh node with respect to the one or more user hotspots;
perform benchmark throughput tests with one or more Wi-Fi enabled devices in at least one of the one or more user hotspots, wherein the benchmark throughput tests of the one or more Wi-Fi enabled devices are performed at a plurality of known distances from the mesh node by moving the mesh node between consecutive throughput tests;
recommend moving the mesh node a distance and direction to improve benchmark throughput test results with the one or more Wi-Fi enabled devices in at least one of the one or more user hotspots;
display a mapping of throughput test data at all of the one or more user hotspots with respect to various testing positions of the mesh node; and
determine an optimal position of the mesh node for throughput signal strength in the one or more user hotspots based on the throughput test data.
